(19) United States
(12) Patent Application Publication
(10) Pub. No.: US 2002/0046083 A1
(43) Pub. Date: Apr. 18, 2002

(54) AFTER-SALES CUSTOMIZATION SPECIFIED BY RETAILER ACTS AS INCENTIVE

(75) Inventor: KRISTEN DIANE ONDECK, BURLINGAME, CA (US)

Correspondence Address: Corporate Patent Counsel, Philips Electronics North America Corporation, 580 White Plains Road, TARRYTOWN, NY, 10591, US

(73) Assignee: PHILIPS ELECTRONICS NORTH AMERICA CORPORATION

(21) Appl. No.: 09/349,676

(22) Filed: Jul. 8, 1999

(51) Int. Cl. G06F 17/60

(52) U.S. Cl. 705/14; 705/27

(57) ABSTRACT

A machine-implemented method of doing business enables to stimulate commercial activities. A customer notifies a manufacturer or a dedicated service provider, of the purchase of merchandise from a specific retailer. Upon being notified, the manufacturer or service provider customizes a portal or home page for the customer by temporarily adding an advertisement banner associated with the retailer.

### FIELD OF THE INVENTION

The invention relates to a machine-implemented method of doing business to stimulate commerce, especially, but not exclusively, as related to sales of merchandise, such as a product of manufacture or a service.

### BACKGROUND ART

A business model typically comprises strategies for achieving certain business goals, e.g., providing better service to customers, outperforming competitors, entering new markets, adapting to changes, etc.

The Internet has caused new business models to emerge. Some examples thereof are conducting business on-line, also referred to as electronic commerce or e-commerce, the use of advertizing banners at Web portals, upgrading or customizing consumer electronics (CE) equipment via the Internet, identifying potential customers through user-profiling based on their history of accessing Web sites, providing up-to-date information about products and services, such as data handbooks, at Web sites specifically designed for that purpose and equipped with search engines, etc.

### SUMMARY OF A PREFERRED EMBODIMENT OF THE INVENTION

Among other things, the invention addresses ways to improve a bargaining position that a product manufacturer or service provider has with a retailer, ways to increase the retailer's incentive to sell the product or service, and proposes a business model from which both manufacturer, retailer and customer benefit.

The invention provides a machine-implemented method of doing business that enables to stimulate commercial activities. According to the method a customer is enabled to notify a specific party, e.g., a manufacturer, importer, or distributor, or a specialized service provider, of a specific commercial activity wherein he or she is or was involved. Upon being notified, the party enables customizing, via a data network such as the Internet, the equipment of the customer as associated with the commercial activity. For example, the specific activity relates to sales of merchandise via a retailer, and the customer notifies the specific party of the purchase of the merchandise from the retailer. When the party has been notified, it enables customizing Internet-enabled or upgradeable electronic equipment of the customer, via the Internet, as associated with the specific retailer from whom the merchandise was purchased. For example, the merchandise is related to the Internet (software application or hardware device) and the customer has purchased it to make it part of his/her Internet-enabled equipment. The merchandise is enabled to be customized via the Internet, preferably according to specifications from the retailer, and also according to input as to, e.g., the intended usage, supplied by the customer at the time when the specific party was notified.

Advantages are manifold. For example, the invention enables the manufacturer to create a single-version product. The product can be dynamically customized, post-sale, to the retailer's specifications, thereby making it an exclusive product. This decreases the cost of providing exclusive features to a retailer. Currently, a manufacturer may add an extra software application to an electronic device. The manufacturer would have to manually install this software or add a disk to the package, for all versions of their product that are to go to a plurality of retailers. With the invention an exclusive product is created without extra overhead, both for the manufacturer and for the retailer. Furthermore, the specific retailer knows the sales climate in his/her region, his/her type of clients, his/her local competitors and is therefore better equipped to more efficiently customizing the merchandise according to the local circumstances. In this fashion, too, the customer gets a better product or service for a better price. As another example, the customer's Internet-enabled equipment has a home page (portal or gateway) that can be programmed by the specific party to show an advertisement associated with the retailer.

### BRIEF DESCRIPTION OF THE DRAWINGS

The invention is explained by way of example and with reference to the accompanying drawings, wherein:

FIGS. 1 and 2 are block diagrams of a system for implementing the method of the invention in various scenarios.

Throughout the figures, same reference numerals indicate similar or corresponding features.

### DETAILED EMBODIMENTS

The inventor suggests a new business model for the sales of products or services that is especially interesting to Internet-enabled and/or after-market upgradeable electronic devices or software applications. For example, when a customer has purchased a device or a service via a retailer, the customer is requested, for example as part of a registration procedure, to return information about the purchase (e.g., “where did you buy it?”) to the manufacturer or importer or distributor. Based on this information, the Internet-enabled device, e.g., a InternetTV or other set top box, is customized so that, e.g., a home web-site for the device carries an advertisement banner of the retailer and a link to the retailer's home page for some time period.

Specific embodiments of the invention can be used to improve a bargaining position that a product manufacturer has with a retailer by increasing the retailer's incentive to sell the manufacturer's product. This benefits both the manufacturer and the retailer. Specific embodiments of the invention enable the manufacturer to create a single-version product, which post-sale can be dynamically customized to the retailer's specifications, thus, making it an exclusive product. This decreases the cost of providing exclusive features to a retailer. For example: currently, a manufacturer may add an extra software application to an electronic device. The manufacturer would have to manually install this software or add a disk to the package, for all versions of Product X that are to go to Retailer Y. In the invention there is no extra overhead, neither for the manufacturer nor for the retailer, to create an exclusive product. And, there is very minimal effort required from the customer.

Specific embodiments of the invention involve customizing a web site or the features of an electronic device or of a software application, based on the entries that a user fills out on a form. More specifically, as part of the on-line product-registration, users are asked to specify where they purchased the device of the software. Certain features of the web site or features of the electronic device or software are then altered on-line based on their answers. For example: If a customer bought Product X at Retailer Y, then entered Retailer Y as the “Location of Purchase” on his/her Registration Form, a portion of the web site is reserved for Retailer Y to use for his purposes to gain contact with the customer. This can be a marketing incentive to encourage the retailer to increase their sales of Product X.

The level of customizing given to the retailer may vary depending on the retailer's offering to the manufacturer. Three models are briefly discussed below, by way of example, for basic advertisement, extended advertisement, and customized feature.

Basic advertisement: The manufacturer gives the retailer a small advertisement on the customer's home page of the web site for the duration of, e.g., one month after the user has registered on-line. This ad may be made to link to the retailer's web site. In return, the retailer promises to put the product on display for, say, six months and in a prominent place in his/her store.

Extended advertisement: The manufacturer leases for free to the retailer a larger advertisement on the customer's home page of the web site for the duration of a longer time period, e.g., three months. This ad links through to a special coupon section that is managed by the manufacturer. It also links to t retailer's web site. The retailer promises to feature the manufacturer's product in his/her advertising and lower the retailer's profit on the product.

Customized feature: The manufacturer provides to the retailer an exclusive product feature. The retailer promises to sell the manufacture's product exclusively for a certain time period.

In both the basic advertisement and the extended advertisement scenario, the customer's home page is typically a portal. A portal, also referred to as gateway, serves as a starting site for users when they connect to the World Wide Web. Yahoo and PlanetSearch are examples of portals. Access providers, such as America OnLine (AOL) provide their own portals to the Web for their users. Portals have the opportunity to attract large numbers of viewers. As a consequence, screen real-estate for advertisement banners at a portal is valuable.

Note that the invention enables customizing a portal per individual viewer. The portal or home page, or a portion thereof, is then customized for each customer individually from a kit of appropriate parts (advertisement banners, collection of hyperlinks, ornamental aspects, etc.) supplied by the server and based on a set of parameters submitted by the customer. These parameters include information about the user, e.g., as supplied when the user registers his/her purchase on-line. These parameters also may include information from the accessing client device identifying its capabilities and configuration. Within this context, reference is made to U.S. Ser. No. 08/785,459 (attorney docket PHA 23,217) filed Jan. 17, 1997 for Mehran Moshfeghi, Jun Wang, Stephen Wong and Yuan-Pin Yu for A METHOD FOR PERSONALIZING HOSPITAL INTRANET WEB SITES, herein incorporated by reference. This patent document relates to a system wherein a web server is accessible by a web browser via a network, wherein the presumed needs, declared and/or logged topics of interests, access rights to information and environments of users are taken into account in presenting web pages to a user's web browser. Web pages are created dynamically based on the user's relationship to the institution or the patient, and the users' function or job, and information access privileges. Furthermore the web pages are created dynamically based on the capabilities of the users' computers, computer bandwidth connection, display characteristics, browser capabilities, etc. In order to achieve this the web server has to be supplied with information about the user and the user's environment. This information can be obtained with the use of web forms, automatic detection of the IP address of the requesting client, server-browser communication, smart cards and/or active badges. Information about user preferences, user's physical and computer environment, and usage profile can be stored at the server. The server can then use all this information to generate personalized content.

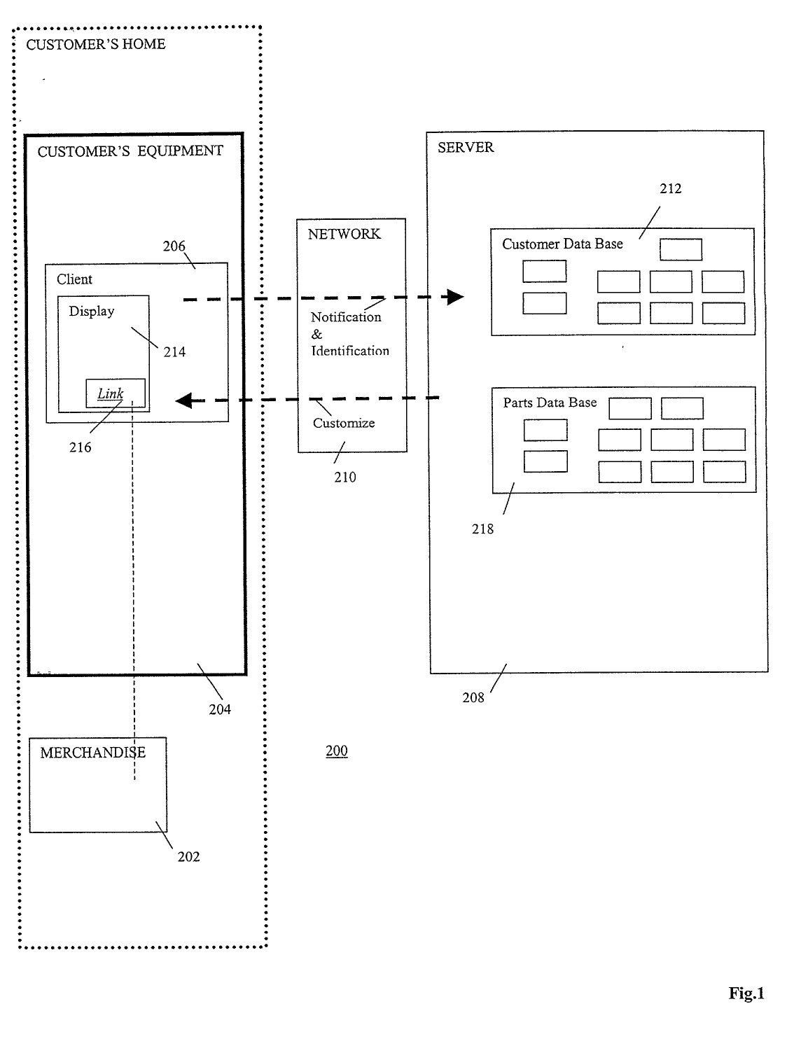

FIG. 1 is a block diagram of a system 200 for implementing a method according to the invention. System 200 has a client-server architecture. The scenario here is that the customer has bought a product 202, e.g., a mountain bike, from a specific retailer. The customer has equipment 204, e.g., a home network that has one or more sub-systems for, e.g., home entertainment through video and audio, home automation such as in-house climate control or a security system, data communication, etc. At least a component 206 in equipment 204 is network-enabled so as to communicate with a server 208 via a network 210, e.g., the Internet. Upon the purchase of merchandise 202 the user is requested to carry out the procedures for registration, e.g., for the purpose of the product's warrant policy, by sending a notification to a specific site, here server 208. Together with this notification, the user can provide information that enables identifying and profiling the user and his/her equipment within a relevant context. Upon receipt of the notification and further information, server 208 stores the profile in a data base 212. Server 208 comprises, is part of, or cooperates with, another server for providing a home page or portal to the user. The portal is accessible via client's display 214 and PC or set top box (not shown). This other service is not shown here in order not to obscure the drawing. Now, based on the information received as a result of the purchase of mountain bike 202, server 208 customizes this user's portal site so that it shows, for example, an advertisement banner 216 with a hyperlink to the retailer's web site for the duration of, say 6 months. The banner may comprise electronic coupons that allow the user to purchase bike accessories from the retailer at an interesting discount. The retailer may decide to offer a different accessory each month so as to keep the customer interested. The banner is in this case updated every month via server 208. Different customers having made different purchases get differently customized portals created by collating relevant parts from a database 218 that are selected on the information comprised in the notification or notification history.

Now consider merchandise 202 to comprise an electronic device whose software is upgradeable or exchangeable. For example, merchandise 202 comprises a remote control, a personal digital assistant (PDA), a television receiver, a radio, or a programmable remote control device, etc. Upon the user notifying server 208 of his/her purchase, server 208 informs the user of option to customize merchandise 202 and how this is to be brought about. For example, the user is instructed how to download a software application or content information via the Internet 210 into his/her PC 206. Electronic device 202 is thereupon connected via a cable or via wireless communication to PC 206 for being upgraded or customized by means of the data or application previously downloaded into PC 206. Within this context see, for example, U.S. Ser. No. 09/271,200 (attorney docket PHA 23,607) filed Mar. 17, 1999 for Jan van Ee for FULLY FUNCTIONAL REMOTE CONTROL EDITOR AND EMULATOR, incorporated herein by reference. This document relates to a method of enabling programming an electronic device, here a programmable remote control device, such as the really cool “Pronto” of Philips Electronics, for control of electronic equipment. The method comprises enabling running a software application on a computer for emulating manual programming of the device upon user input. The method further comprises enabling downloading into the device a result from the emulated manual programming. Preferably, the user is enabled to control the equipment from the computer upon the emulated programming in order to verify the programmed steps. This requires that the computer communicate with the equipment as if it were the remote. If the remote contains an IR or RF transmitter, the computer communicates through a similar IR or RE transmitter, for example. This example merely illustrates the scenario of the two-step upgrading and is not to be construed so as to limit the scope of the invention. Accordingly, the user can have his electronic device customized via PC 206 in response to notifying server 208.

Now consider merchandise 202 itself to be an Internet-enabled apparatus. A similar purchase-driven scenario is applicable as discussed above regarding upgradeable electronic devices, but now without intervention of a PC 206 or a set top box as intermediate. Alternatively, or subsidiarily, if merchandise 202 has itself a display and a browser (e.g., a PC), or has a browser and can be connected to a display (e.g., a set top box), merchandise 202 can be customized with regard to its application software, and the home page with regard to its advertisement banner as discussed above.

Consider the merchandise 202 to comprise an on-line service, e.g., an electronic program guide (EPG), a news service, an email service, a telephone or video conferencing service, etc. Again, the user's Internet-enabled equipment can be customized in ways to provide individual tailoring of software or portal in the fashion discussed above: e.g., video processing applications tailored to the processing power of the user's equipment, or an advertisement banner on the service's portal or a home page associated with the service.

Above examples of purchase driven scenario's can, where applicable, be implemented also for on-line sales, wherein the device itself may get customized automatically at a remote location, i.e., before merchandise 202 arrives at the customer's for operational use.

Further note that the screen real estate assignment can be customized per individual customer and per commercial transaction (e.g., purchase, lease) and per portal.

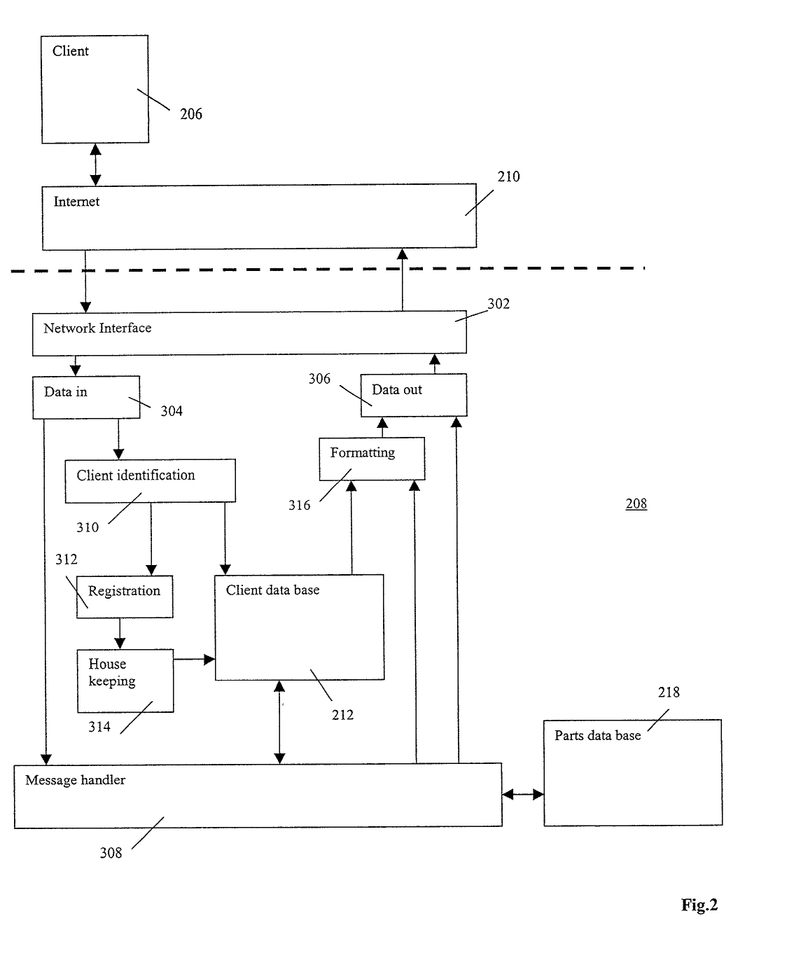

As discussed above the invention relates to a client-server architecture for the delivery of customized content by a server to client devices. The delivery is tailored both to the user and his/her client device(s). The client device accommodates a small software application that is activated, e.g., when the device is turned on and gets on-line. The software application establishes a connection via the Internet to the server. In response to the connection with the server, the client device brings up a home page. The home page is built from a kit of appropriate parts supplied by the server and based on a set of parameters submitted by the user. These parameters include, for example, both information from the accessing client device identifying its capabilities and configuration and also information stored about the user (supplied either explicitly or gathered implicitly) from a database. These functional features of server 208 in FIG. 1 are illustrated in FIG. 2. An interface 302 links server 208 to data network 210. Multiple clients, among which client 206, are connected to server 208 via network 210. Interface 302 handles both receipt of messages for a data-input stage 304, and sending of messages for a data output stage 306. Both stages 304 and 306 communicate directly with, and are controlled by, a main processor 308 handling request management and communicates with parts database 217. The data received at input stage 304 is separated into identification data and content data. The identification data is passed to a client identification stage 310 for identification purposes. The content data portion is passed on directly to processor 308 for the managing of the message. Client identification stage 310 compares the received identification data with the identification data stored in database 212 for determining whether or not the received data is from a client who has already registered with database 212 or not. If the identification data received does not match with the data in database 212, client identification stage 310 triggers the updating of database 212 with the new client's identification data via a registration handler stage 312 and a house keeping stage 314. Checks on registration form part of the general system housekeeping function implemented by stage 314 which may periodically sweep client database 212 to remove identification data of clients from whom no contact has been received for a predetermined period (suitably a fairly long lay-off of up to, for example, 2 years is allowable). Upon the registration of the new client or upon finding the requesting client having registered on a previous occasion, processor 308 handles the client's request, and collates the data for the personalized site from parts in database 218. Database 218 comprises, for example, the software building blocks for selectively creating advertisement banners and hyperlinks associated with the specific retailers and the specific merchandise. The collated data is formatted in a formatting stage 316 which puts it into the particular format for that particular user by reference to both stored user preferences and an indication of the current client capabilities, as held in the database 212.

Within this context, reference is made also to the cookie technology that enables a server to create a personalized home page for each individual user. As known, the term “cookie” refers to a message that a server supplies to a web browser for local storage as a text file at the client when the client visits a specific web site for the first time. Each next time the browser interacts with the specific site the cookie is returned to the server. Cookies allow to identify users and to create personalized web pages. A cookie can be based on information that the user is asked to provide such as the user's name and interests.

The patent documents listed below are incorporated herein by reference. The documents discuss further examples of customizing equipment or services via the Internet.

U.S. Ser. No. 09/160,490 (attorney docket PHA 23,500) filed Sep. 25, 1998 for Adrian Turner et al., for CUSTOMIZED UPGRADING OF INTERNET-ENABLED DEVICES BASED ON USER-PROFILE. This document relates to a server system that maintains a user profile of a particular end-user of consumer electronics network-enabled equipment and a data base of new technical features for this type of equipment, e.g., a home network. If there is a match between the user-profile and a new technical feature, and the user has indicates to prefer receiving information about updates or sales offers, the user gets notified via the network of the option to obtain the feature.

U.S. Ser. No. 09/189,535 (attorney docket PHA 23,527) filed Nov. 10, 1998 for Yevgeniy Shteyn for UPGRADING OF SYNERGETIC ASPECTS OF HOME NETWORKS. This document relates to a system with a server that has access to an inventory of devices and capabilities on a user's home network. The inventory is, for example, a look-up service as provided by HAVi, JINI and Home API architectures. The server has also access to a data base with information of features for a network. The server determines if the synergy of the apparatus present on the user's network can be enhanced based on the listing of the inventory and on the user's profile. If there are features that are relevant to the synergy, based on these criteria, the user gets notified.

Both these documents relate to the SmartConnect (TM) initiative of Philips Electronics.

U.S. Ser. No. 09/283,545 (Attorney docket PHA 23,633) filed Apr. 1, 1999 for Yevgeniy Shteyn for TIME- AND LOCATION-DRIVEN PERSONALIZED TV. This document relates to a method of enabling a user to access content information (e.g., video, audio). The method enables the user to select the content information, e.g., from an electronic program guide relating to a broadcast or multicast service. The selected content information gets recorded when it is broadcasted or multicasted. The method enables the user to select in advance at least a specific one from multiple geographically different locations at which the recorded, selected content information will be made available for playout. Preferably, the invention also enables the user to specify a time frame for making the recorded content information available for play-out at the specific location. The content information can be recorded at a first recording system, e.g., at a server, whereafter the recorded selected content information is streamed over a data network, e.g., over the Internet or a private network like AOL, from the first recording system to the location specified by the user. If the specific location has a second recording system, the streaming uses a low-bandwidth protocol so as to keep Internet bandwidth usage low while recording at the second recording system. This method is based on an insight that several technological and demographic trends are emerging and gaining momentum: personalized information through Internet portals such as the web sites “my.yahoo.com”, “my.excite.com”, “cnn.com”, etc . . . ; personalized TV such as provided by TiVo, Inc.; the availability of EPG's; home networking and home automation infrastructures, e.g., HAVi, Home API, JINI., tailored to the individual's equipment, preferences and needs; teleconferencing; and an increasing mobility of the individual: business travel and recreational travel, and as a consequence thereof, an increasing demand for high quality services. Accordingly, the invention attempts to contribute to the user's needs by means of enabling shifting of recording and play-out locations, in addition to the time-shifting provided by the known services.

U.S. Ser. No. 09/311,128 (Attorney docket PHA 23,501) filed May 13, 1999 for Joost Kemink for INTERNET-BASED SERVICE FOR UPDATING A PROGRAMMABLE CONTROL DEVICE. This document relates to providing an Internet-based service for updating or customizing a programmable control device. An Internet site contains links to appliance-dependent control and feature option information which can be downloaded to the programmable control as a graphic user interface (GUI). A user interface is provided at the site for the user to easily specify a target appliance, and thereafter selectively download the interface and control information that is available for the target appliance. The Internet site also contains links to other providers of configurations and macros, such as system integrators who provide interfaces based on an inventory of the user's controllable equipment, hobbyist who share configurations and macros that they've found useful, and so on.

U.S. Ser. No. 09/165,682 (PHA 23,484) filed Oct. 2, 1998 for Yevgeniy Shteyn for CONTROL PROPERTY IS MAPPED ONTO MODALLY COMPATIBLE GUI ELEMENT. This document relates to an information processing system, especially to a system based on Home API. The system has an electronic device and a controller for control of a functionality of the device. An abstract representation of the functionality is provided to the controller. The abstract representation exposes a modality of controlling the functionality. The controller enables controlling the functionality through interaction with the abstract representation. The modality controls associating the control of the functionality with a modally compatible controlling capability of the controller. The modality exposed can be, for example, “Boolean”, “float”, “integer array”.

I claim:

1. A machine-implemented method of doing business comprising:
enabling to stimulate commercial activities, the enabling comprising:
enabling to be notified by a customer of a specific one of the commercial activities;
upon being notified, enabling customizing, via a data network, of equipment of the customer as associated with the commercial activity.

2. The method of claim 1, wherein:
the commercial activities comprise sales of merchandise;
the enabling to be notified comprises enabling to be notified of a purchase of the merchandise; and
the enabling customization comprises enabling customizing of the equipment as associated with the purchase of the merchandise.

3. The method of claim 2, wherein:
the purchase is from a specific retailer; and
the customizing comprises customizing as associated with the specific retailer.

4. The method of claim 2, wherein:
the data network comprises the Internet;
the merchandise is related to the Internet; and
the merchandise is part of the equipment and capable of being customized via the Internet.

5. The method of claim 4, wherein the merchandise is capable of being customized according to a specification from the retailer.

6. The method of claim 4, wherein the merchandise is capable of being customized according to input from the customer.

7. The method of claim 1, wherein the customizing comprises individualizing a home page for the customer.

8. The method of claim 7, wherein the individualizing comprises creating an advertisement for a specific retailer.

9. The method of claim 8, wherein the advertisement is user-interactive.
